(19) United States
(12) Patent Application Publication
(10) Pub. No.: US 2019/0135179 A1
(43) Pub. Date: May 9, 2019

(54) VEHICLE AND CONTROL METHOD THEREOF

(71) Applicants: Hyundai Motor Company, Seoul (KR); Kia Motors Corporation, Seoul (KR)

(72) Inventor: Jonghyuck LEE, Hwaseong-si (KR)

(73) Assignees: Hyundai Motor Company, Seoul (KR); Kia Motors Corporation, Seoul (KR)

(21) Appl. No.: 15/911,386

(22) Filed: Mar. 5, 2018

(30) Foreign Application Priority Data
Nov. 8, 2017 (KR) 10-2017-0147697

(51) Int. Cl. B60Q 9/00; B60T 7/22; G01S 15/93; G01S 13/93

(52) U.S. Cl. CPC B60Q 9/008; B60T 7/22; G01S 15/931; G01S 2013/9346; B60T 2201/022; B60T 2210/32; G01S 13/931

(57) ABSTRACT

A vehicle may include an obstacle detector detecting an obstacle and generating detection data based on at least one of a radar detector and a camera, an ultrasonic detector configured for detecting an obstacle by transmitting ultrasounds and receiving ultrasounds reflected from an object, and a controller configured to determine a distance between the vehicle and an obstacle based on detection data of the obstacle detector when the obstacle exists in a detection area of the obstacle detector, and determine a distance between the vehicle and the obstacle based on detection data of the ultrasonic detector when the obstacle exists in a detection area of the ultrasonic detector.

### CROSS-REFERENCE TO RELATED APPLICATION

The present application claims priority to Korean Patent Application No. 10-2017-0147697 filed on Nov. 8, 2017, the entire contents of which is incorporated herein for all purposes by this reference.

### BACKGROUND OF THE INVENTION

### Field of the Invention

The present invention relates to a vehicle and control method thereof to determine a correct position of an obstacle even in an area hard for an obstacle detector configured to make a detection thereof.

### Description of Related Art

The Front Collision Warning system (FCW) and the Forward Collision-Avoidance Assist system (FCA) refer to a device to avoid a collision or minimize damage from the collision by recognizing an obstacle with an obstacle detector, such as a radar sensor or a camera and giving a warning to the driver if a collision is predicted or automatically activating the brake in an emergency.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a vehicle and control method thereof to determine a correct position of an obstacle even in an area hard for an obstacle detector configured to make a detection.

Additional aspects of the exemplary embodiments will be set forth in part in the description which follows and, in part, will be obvious from the description, or may be learned by practice of the exemplary embodiments.

According to an aspect of an exemplary embodiment of the present invention, there is provided a vehicle. The vehicle may include an obstacle detector detecting an obstacle and generating detection data based on at least one of a radar detector and a camera, an ultrasonic detector configured for detecting an obstacle by transmitting ultrasounds and receiving ultrasounds reflected from an object, and a controller configured to determine a distance between the vehicle and an obstacle based on detection data of the obstacle detector when the obstacle exists in a detection area of the obstacle detector, and determine a distance between the vehicle and the obstacle based on detection data of the ultrasonic detector when the obstacle exists in a detection area of the ultrasonic detector.

The detection area of the obstacle detector may be located farther from the vehicle than the detection area of the ultrasonic detector is.

The controller may be configured to determine a distance between the vehicle and the object based on a combination of detection data of the obstacle detector and detection data of the ultrasonic detector when the obstacle may exist in an overlapping area between the detection area of the obstacle detector and the detection area of the ultrasonic detector.

The controller may be configured to give a warning to a driver based on the determined distance.

The controller may be configured to give a different warning to the driver when the obstacle exists in an overlapping area between the detection area of the obstacle detector and the detection area of the ultrasonic detector but the distance between the vehicle and the obstacle may be equal to or less than a predetermined reference distance.

The controller may be configured to determine a distance between the vehicle and the obstacle based on detection data of the ultrasonic detector when the obstacle may exist in an area other than the detection area of the obstacle detector and in the detection area of the ultrasonic detector.

The controller may be configured to perform braking control when the obstacle exists in an area other than the detection area of the obstacle detector and in the detection area of the ultrasonic detector and when the distance between the vehicle and the obstacle may be equal to or less than a predetermined reference distance.

According to an aspect of another exemplary embodiment of the present invention, there is provided a control method of a vehicle. The control method may include detecting an obstacle with an obstacle detector including at least one of a radar detector and a camera and generating detection data, and determining a distance between the vehicle and an obstacle based on detection data of the obstacle detector when the obstacle exists in a detection area of the obstacle detector, and determining a distance between the vehicle and the obstacle based on detection data of the ultrasonic detector when the obstacle exists in a detection area of the ultrasonic detector.

The detection area of the obstacle detector may be located farther from the vehicle than the detection area of the ultrasonic detector is.

The determining of a distance between the vehicle and an obstacle may include determining a distance between the vehicle and the object based on a combination of detection data of the obstacle detector and detection data of the ultrasonic detector when the obstacle may exist in an overlapping area between the detection area of the obstacle detector and the detection area of the ultrasonic detector.

The control method may further include giving a warning to a driver based on the determined distance.

The control method may further include giving a different warning to the driver when the obstacle exists in an overlapping area between the detection area of the obstacle detector and the detection area of the ultrasonic detector but the distance between the vehicle and the obstacle may be equal to or less than a predetermined reference distance.

The determining of a distance between the vehicle and an obstacle may include determining a distance between the vehicle and the obstacle based on detection data of the ultrasonic detector when the obstacle may exist in an area other than the detection area of the obstacle detector and in the detection area of the ultrasonic detector.

The control method may further include performing braking control when the obstacle exists in an area other than the detection area of the obstacle detector and in the detection area of the ultrasonic detector and when the distance between the vehicle and the obstacle may be equal to or less than a predetermined reference distance.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is an external view of a vehicle, according to an exemplary embodiment of the present invention.

FIG. 2 and FIG. 3 are views for explaining how to determine the position of an obstacle based on detection data.

FIG. 4 is a flowchart of operation of a control method of a vehicle, according to an exemplary embodiment of the present invention.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Additionally, various exemplary embodiments will now be described more fully hereinafter with reference to the accompanying drawings. The exemplary embodiments may, however, be embodied in various forms and should not be construed as being limited to the exemplary embodiments set forth herein. These embodiments are provided so that the present disclosure will be thorough and complete and will fully convey the exemplary embodiments to those of ordinary skill in the art. Like numerals denote like elements throughout.

It will be understood that, although the terms first, second, etc. may be used herein to describe various elements, these elements should not be limited by these terms. These terms are only used to distinguish one element from another. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

The terminology used herein is for the purpose of describing various exemplary embodiments only and is not intended to be limiting. As used herein, the singular forms “a,” “an,” and “the,” are intended to include the plural forms as well, unless the context clearly indicates otherwise.

Reference will now be made more specifically to the exemplary embodiments of the present invention, examples of which are illustrated in the accompanying drawings, wherein like reference numerals refer to like elements throughout.

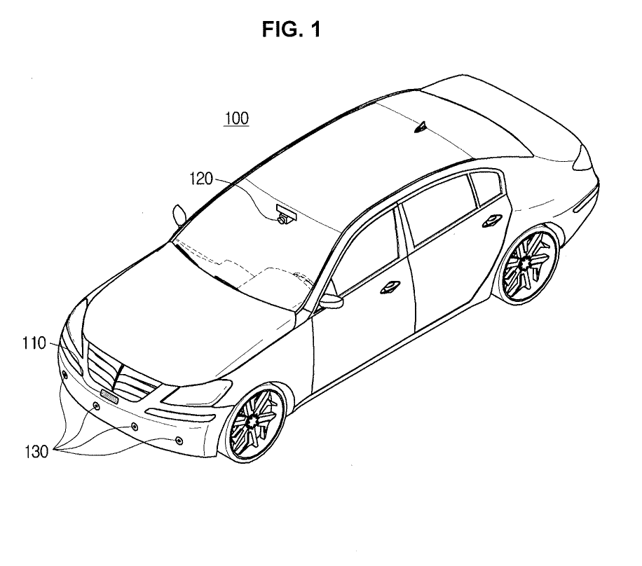

FIG. 1 is an external view of a vehicle, according to an exemplary embodiment of the present invention.

Referring to FIG. 1, the vehicle 100 may include a detecting device including an obstacle detector for detecting an obstacle in front of, on sides of or behind the vehicle 100, a rainfall detector for detecting precipitation and whether it is raining, etc.

The obstacle detector may include at least one of a radar detector 110 and a camera 120, each of which may be disposed in the vehicle 100 in the plural. Although one of the radar detectors 110 is disposed on the front bumper of the vehicle 100 and one of the cameras 120 is disposed on the upper end portion of the front windshield glass in FIG. 1, the position and number of the radar detector 110 and the camera 110 are not limited thereto. For example, only one of the radar detector 110 and the camera 120 may be disposed in the vehicle 100.

The radar detector 110 detects a distance, direction, altitude, speed, etc., of an object by irradiating electronic waves (e.g., radio waves, micro waves, etc.) to the object and receiving electronic waves reflected from the object. The radar detector 110 may include a radar antenna for transmitting electronic waves or receiving electronic waves reflected from the object.

The camera 120 acquires an image of an object and provides the image data to various components in the vehicle 100 including a navigation device.

The detection data of the radar detector 110 and the image data from the camera 120 may be provided to a controller for controlling the components in the vehicle 100.

In the meantime, the radar detector 110 and the camera 120 tend to have difficulty in recognizing an object approaching quite closely to the vehicle 100 or an object approaching in the longitudinal direction of the vehicle 100. To address the present problem, in addition to the radar detector 110 and the camera 120, the vehicle 100 may further include an ultrasonic detector 130 for detecting a nearby obstacle by transmitting ultrasounds and receiving ultrasounds reflected from an object. The detection data of the ultrasonic detector 130 may also be provided to the controller.

One or more ultrasonic detector 130 may be mounted on the vehicle 100. Although four ultrasonic detectors 130 mounted on the front bumper of the vehicle 100 are shown in FIG. 1, the number and position of the ultrasonic detector 130 are not limited thereto.

Each ultrasonic detector 130 may output a time taken to receive a reflected ultrasound as detection data or may output a distance between an obstacle and the ultrasonic detector 130 determined based on the time taken to receive a reflected ultrasound as detection data. In the following description, an example of outputting a distance between each ultrasonic detector 130 and an obstacle as the detection data will be focused.

An obstacle may include an object, a person, or another vehicle located outside the vehicle 100, which is detectable to the radar detector 110, the camera 120, and the ultrasonic detector 130.

The controller is a processor responsible for controlling general operation of the vehicle 100 and controls respective components of the vehicle 100.

The controller may be integrated with a storage medium that may store data, in a System on Chip (SoC) embedded in the vehicle 100. In this regard, there may be not only one but multiple SoCs embedded in the vehicle 100, and the aforementioned components may not be limited to being integrated in a single SoC.

The controller is configured to determine the position of an obstacle based on at least one of detection data of the obstacle detector 110, 120 and detection data of the ultrasonic detector 130, and to generate a control signal to control the components of the vehicle 100 based on the position of the obstacle.

The controller may be implemented in a single extra module for determining the position of an obstacle, or may be implemented by being integrated in a head device configured for controlling the components of the vehicle 100 including a navigation device, an audio system, an air conditioner, etc.

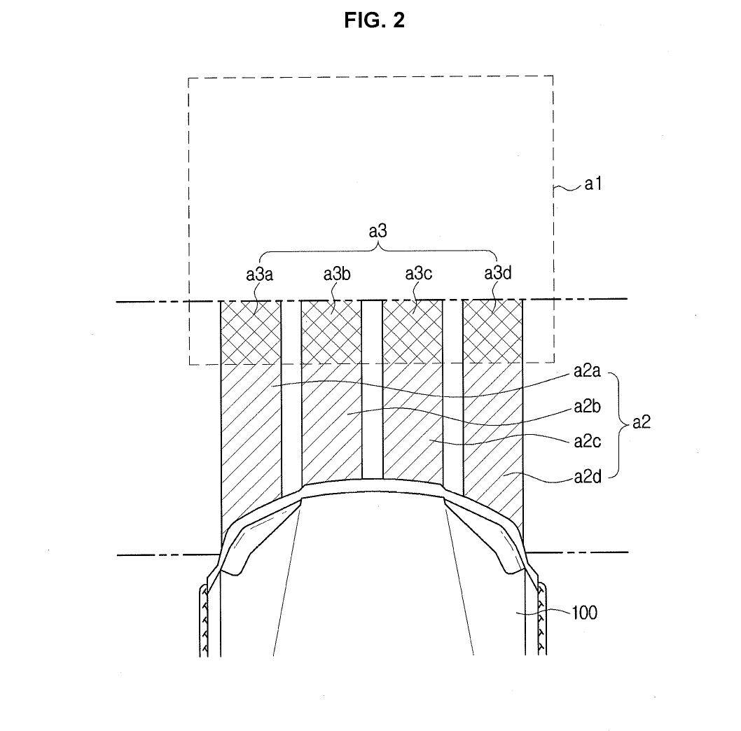

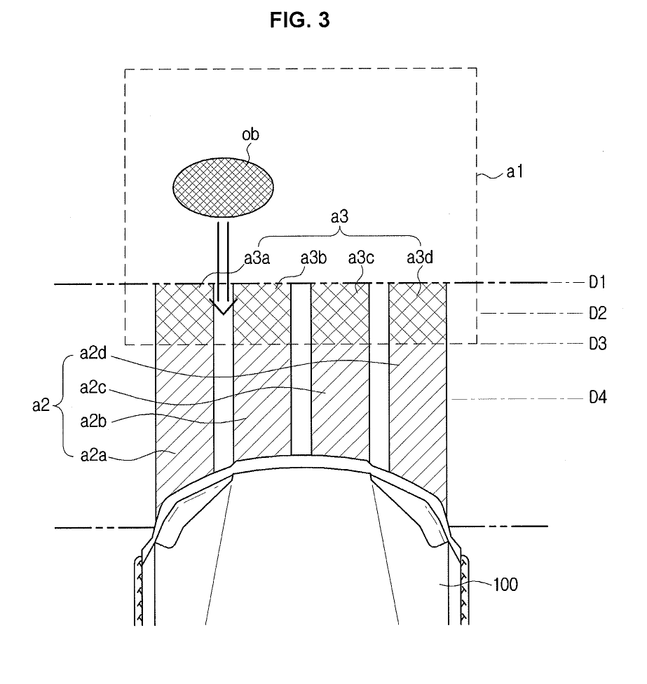

FIG. 2 and FIG. 3 are views for explaining how to determine the position of an obstacle based on detection data. For convenience of explanation, an occasion when the obstacle detector 110, 120 and the ultrasonic detector 130 detect an obstacle located in front of the vehicle 100 will be referred to as an example.

Referring to FIG. 2 and FIG. 3, the obstacle detector 110, 120 may detect an obstacle located in front of the vehicle 100 and may detect an obstacle that exists in an area a1 depending on its detection performance.

When there is an obstacle ob existing in the detection area a1 of the obstacle detector 110, 120, the controller is configured to determine a distance between the vehicle 100 and the obstacle ob based on the detection data of the obstacle detector 110, 120.

The controller may also give a warning or alarm to the driver based on the time-changing distance between the vehicle 100 and the obstacle ob. In the instant case, as for the alarm or warning, the controller may display a warning message through a screen of the navigation device or output a warning sound through a speaker in the vehicle 100.

For example, the controller may reduce the output interval of the warning sound as the distance between the vehicle 100 and the obstacle ob gets shorter.

In the meantime, the ultrasonic detector 130 may also detect an obstacle located in front of the vehicle 100 and may detect an obstacle that exists in another area a2 depending on its detection performance. By the nature of its detection performance, the detection area a2 of the ultrasonic detector 130 is located nearer from the vehicle 100 than the detection area a1 of the obstacle detector 110, 120.

In a case that a plurality of ultrasonic detectors 130 are mounted on the vehicle 100, the ultrasonic detectors 130 may detect an obstacle ob in the respective detection areas a2a, a2b, a2c, a2d, as shown in FIG. 3.

In an exemplary embodiment of the present invention, when the obstacle ob is located in the detection area a1 of the obstacle detector 110, 120 (i.e., the distance between the vehicle 100 and the obstacle ob exceeds D3), the controller of the vehicle 100 may determine a distance between the vehicle 100 and the obstacle ob based on the detection data of the obstacle detector 110, 120 and give a warning to the driver based on the distance.

If the obstacle ob is located not only in the detection area a1 of the obstacle detector 110, 120 but also in the detection area a2 of the ultrasonic detector 130 (i.e., the distance between the vehicle 100 and the obstacle ob is equal to or less than D1 and exceeds D3), the controller may be configured to determine a distance between the vehicle 100 and the obstacle ob based on a combination of the detection data of the obstacle detector 110, 120 and the detection data of the ultrasonic detector 130. It may give a warning to the driver based on the determined distance.

In the case that a plurality of ultrasonic detectors 130 are mounted on the vehicle 100 as shown in FIG. 1, it is also possible for the controller to determine a distance between the vehicle 100 and the obstacle ob based on the combined data when the obstacle ob is located in an overlapping area a3a, a3b, a3c, a3d between the detection area a1 of the obstacle detector 110, 120 and the detection area a2a, a2b, a2c, a2d of the at least two of the ultrasonic detectors 130.

Furthermore, if the obstacle ob is located in an overlapping area between the detection area a1 of the obstacle detector 110, 120 and the detection area a2 of the ultrasonic detector 130 but the distance between the vehicle 100 and the obstacle ob is equal to or less than a predetermined first reference distance D2, the controller may give a different warning to the driver from when the distance between the vehicle 100 and the obstacle ob exceeds the first reference distance D2. Accordingly, the driver may know that an obstacle ob approaches the vehicle 100 closer than a certain reference.

However, when the obstacle ob is located only in the detection area a2 of the ultrasonic detector 130 (i.e., the distance between the vehicle 100 and the obstacle ob is equal to or less than D3), the controller may be configured to determine a distance between the vehicle 100 and the obstacle ob based on the detection data of the ultrasonic detector 130 and give a warning to the driver based on the determined distance. Furthermore, if the obstacle ob is located only in the ultrasound detection area a2 but the distance between the vehicle 100 and the obstacle ob is equal to or less than a second reference distance D4, the controller may perform braking control on the vehicle 100.

The controller, the obstacle detector 110, 120, and the ultrasonic detector 130 may exchange data using a controller area network (CAN) communication scheme.

At least one component may be added or omitted to correspond to the performance of the components of the vehicle 100 shown in FIG. 1. Furthermore, it will be obvious to the ordinary skilled people in the art that the relative positions of the components may be changed to correspond to the system performance or structure.

Some components of the vehicle 100 may be implemented in software, or hardware including Field Programmable Gate Arrays (FPGAs) and Application Specific Integrated Circuits (ASICs).

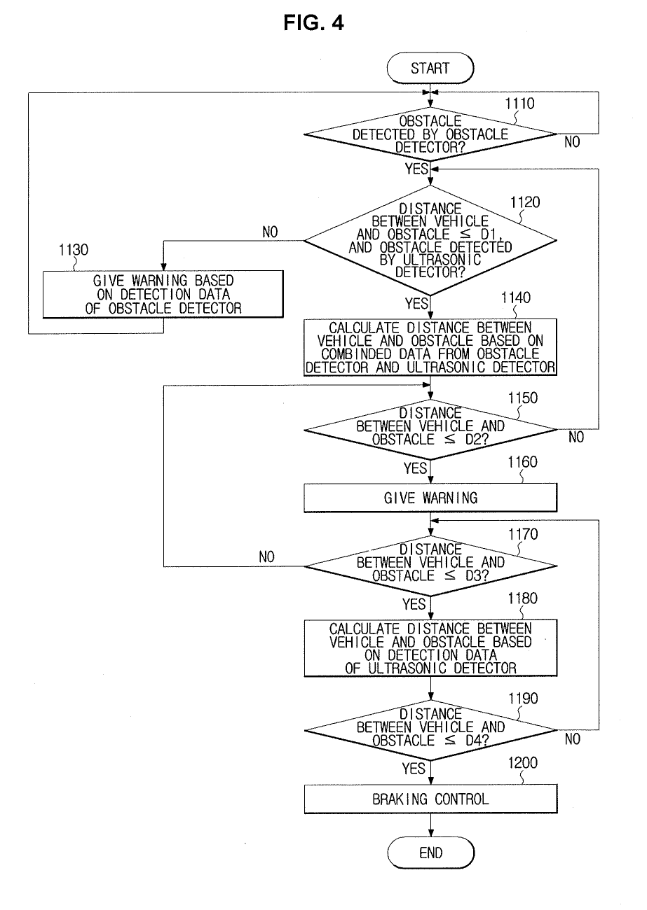

A control method of a vehicle In accordance with various exemplary embodiments of the present invention will now be described with reference to FIG. 4.

FIG. 4 is a flowchart of operation of a control method of a vehicle, according to an exemplary embodiment of the present invention.

First, when a vehicle detects an obstacle around the vehicle through the obstacle detector in 1110, the vehicle estimates a distance between the vehicle and the obstacle based on the detection data of the obstacle detector configured to determine whether the obstacle exists in a detection area of the obstacle detector, and determine whether the obstacle is detected even by the ultrasonic detector (i.e., whether the obstacle exists even in a detection area of the ultrasonic sensor), in 1120.

If the obstacle exists in the detection area of the obstacle detector and is detected even by the ultrasonic detector (i.e., the distance between the vehicle and the obstacle is equal to or less than D1 and exceeds D3 in 1120, the vehicle determines a distance between the vehicle and the obstacle using a combination of the detection data of the obstacle detector and the detection data of the ultrasonic detector, in 1140. The vehicle may give a warning to the driver based on the determined distance, in 1160.

For example, the controller may reduce the output interval of the warning sound as the distance between the vehicle and the obstacle gets shorter.

The combined data may be generated by the controller in a way to complement an error between the detection data of the obstacle detector and the detection data of the ultrasonic detector.

D1 may be a value that varies by the detection performance of the ultrasonic detector, or may be a predetermined value. D3 may be a value that varies by the detection performance of the obstacle detector, or may be a predetermined value.

If the obstacle exists in the obstacle detection area and is not detected by the ultrasonic detector in 1220, the vehicle may give a warning to the driver based on the detection data of the obstacle detector, in 1130.

In the meantime, if an obstacle is detected in both the detection area of the obstacle detector and the detection area of the ultrasonic detector in 1120 but the distance between the vehicle and the obstacle is equal to or less than predetermined D2 (i.e., the distance between the vehicle and the obstacle is equal to or less than D2 and exceeds D3) in 1150, the vehicle may give a different warning to the user from when the distance between the vehicle and the obstacle is equal to or less than D1 and exceeds D2, in 1160. For example, the vehicle may output a different sound or display a different message.

If an obstacle exists only in the detection area of the ultrasonic detector (i.e., the distance between the vehicle and the obstacle is equal to or less than D3) in 1170, the vehicle determines a distance between the vehicle and the obstacle only based on the detection data of the ultrasonic detector, in 1180. D3 may be a value that varies by the detection performance of the obstacle detector, or may be a predetermined value.

On the other hand, if it is determined based on the detection data of the ultrasonic detector that the distance between the vehicle and the obstacle is equal to or less than the predetermined D4, in 1190 even if the obstacle is detected in the detection area of the ultrasonic detector in 1170, the vehicle may perform braking control in 1200.

According to exemplary embodiments of the present invention, a vehicle and control method thereof may improve correctness of estimation of a position of an obstacle by use of a combined data from an obstacle detector and an ultrasonic detector of the vehicle to determine a position of the obstacle.

Exemplary embodiments of the present invention have been described above. In the exemplary embodiments described above, some components may be implemented as a “module”. Here, the term ‘module’ means, but is not limited to, a software and/or hardware component including a Field Programmable Gate Array (FPGA) or Application Specific Integrated Circuit (ASIC), which performs certain tasks. A module may advantageously be configured to reside on the addressable storage medium and configured to execute on one or more processors.

Thus, a module may include, by way of example, components including software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. Furthermore, the components and modules may be implemented such that they execute one or more CPUs in a device.

With that being said, and in addition to the above described exemplary embodiments, embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable code can be recorded on a medium or transmitted through the Internet. The medium may include Read Only Memory (ROM), Random Access Memory (RAM), Compact Disk-Read Only Memories (CD-ROMs), magnetic tapes, floppy disks, and optical recording medium. Also, the medium may be a non-transitory computer-readable medium. The media may also be a distributed network, so that the computer readable code is stored or transferred and executed in a distributed fashion. Still Furthermore, as only an example, the processing element may include at least one processor or at least one computer processor, and processing elements may be distributed and/or included in a single device.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A vehicle comprising:
an obstacle detector detecting an obstacle and generating detection data based on at least one of a radar detector and a camera of the obstacle detector;
an ultrasonic detector configured for detecting the obstacle by transmitting ultrasounds and receiving ultrasounds reflected from the obstacle; and
a controller configured to determine a distance between the vehicle and the obstacle based on detection data of the obstacle detector when the obstacle exists in a detection area of the obstacle detector, and determine a distance between the vehicle and the obstacle based on detection data of the ultrasonic detector when the obstacle exists in a detection area of the ultrasonic detector.

2. The vehicle of claim 1, wherein the detection area of the obstacle detector is located farther from the vehicle than the detection area of the ultrasonic detector is.

3. The vehicle of claim 1, wherein the controller is configured to determine a distance between the vehicle and the object based on a combination of detection data of the obstacle detector and detection data of the ultrasonic detector when the obstacle exists in an overlapping area between the detection area of the obstacle detector and the detection area of the ultrasonic detector.

4. The vehicle of claim 1, wherein the controller is configured to give a warning to a driver based on the determined distances.

5. The vehicle of claim 4, wherein the controller is configured to give a different warning to the driver when the obstacle exists in an overlapping area between the detection area of the obstacle detector and the detection area of the ultrasonic detector but the distance between the vehicle and the obstacle is equal to or less than a predetermined reference distance.

6. The vehicle of claim 1, wherein the controller is configured to determine a distance between the vehicle and the obstacle based on detection data of the ultrasonic detector when the obstacle exists in an area other than the detection area of the obstacle detector and in the detection area of the ultrasonic detector.

7. The vehicle of claim 1, wherein the controller is configured to perform braking control of the vehicle when the obstacle exists in an area other than the detection area of the obstacle detector and in the detection area of the ultrasonic detector and when the distance between the vehicle and the obstacle is equal to or less than a predetermined reference distance.

8. A control method of a vehicle, the control method comprising:
detecting an obstacle with an obstacle detector including at least one of a radar detector and a camera and generating detection data; and
determining a distance between the vehicle and the obstacle based on detection data of the obstacle detector when the obstacle exists in a detection area of the obstacle detector, and determining a distance between the vehicle and the obstacle based on detection data of the ultrasonic detector when the obstacle exists in a detection area of the ultrasonic detector.

9. The control method of claim 8, wherein the detection area of the obstacle detector is located farther from the vehicle than the detection area of the ultrasonic detector is.

10. The control method of claim 8, wherein the determining of the distance between the vehicle and the obstacle includes determining a distance between the vehicle and the object based on a combination of detection data of the obstacle detector and detection data of the ultrasonic detector when the obstacle exists in an overlapping area between the detection area of the obstacle detector and the detection area of the ultrasonic detector.

11. The control method of claim 8, further including: giving a warning to a driver based on the determined distance.

12. The control method of claim 11, further including: giving a different warning to the driver when the obstacle exists in an overlapping area between the detection area of the obstacle detector and the detection area of the ultrasonic detector but the distance between the vehicle and the obstacle is equal to or less than a predetermined reference distance.

13. The control method of claim 8, wherein the determining of the distance between the vehicle and the obstacle includes determining a distance between the vehicle and the obstacle based on detection data of the ultrasonic detector when the obstacle exists in an area other than the detection area of the obstacle detector and in the detection area of the ultrasonic detector.

14. The control method of claim 8, further including: performing braking control of the vehicle when the obstacle exists in an area other than the detection area of the obstacle detector and in the detection area of the ultrasonic detector and when the distance between the vehicle and the obstacle is equal to or less than a predetermined reference distance.
